(19) United States
(12) Patent Application Publication
(10) Pub. No.: US 2015/0034310 A1
(43) Pub. Date: Feb. 5, 2015

(54) COMPOUNDS, COMPOSITIONS AND METHODS FOR ENHANCING OIL RECOVERY

(71) Applicant: IONIC RESEARCH TECHNOLOGIES LLC, South Bend, IN (US)

(72) Inventors: Joan F. Brennecke, Granger, IN (US); Edward J. Maginn, South Bend, IN (US); Mark J. McCready, Granger, IN (US); William F. Schneider, Granger, IN (US); Mauricio Quiroz Guzman, Mishawaka, IN (US)

(21) Appl. No.: 14/450,049

(22) Filed: Aug. 1, 2014

Related U.S. Application Data
(60) Provisional application No. 61/860,975, filed on Aug. 1, 2013.

(51) Int. Cl. C09K 8/58; E21B 43/16; E21B 47/06; E21B 33/10

(52) U.S. Cl. CPC C09K 8/58; E21B 33/10; E21B 43/164; E21B 47/06
USPC 166/250.12; 507/244; 507/251

(57) ABSTRACT

Described herein are compounds, compositions, and methods for enhancing oil recovery.

### CROSS-REFERENCE TO RELATED PATENT APPLICATION

The present application claims the benefit of priority from U.S. Provisional Patent Application Ser. No. 61/860,975, filed Aug. 1, 2013, the contents of which are hereby incorporated herein by reference in their entirety.

### BACKGROUND

Enhanced oil recovery using CO₂ flooding is a productive, profitable, long-used technology. However, a significant limitation to the profit and productivity is that the volume fraction of useful petroleum liquids obtained from the producing wells is typically less than 10%. The portion of water may be ˜20% and the rest either CO₂ or methane. This 70%+ of gas means that a great deal of the CO₂ flow is simply bypassing volumes of rock that contain recoverable oil and hence is being pumped through the field unproductively. Consequently, many different techniques have been tried to reduce the bypass including targeting a specific location in the well for injection, slugs of drilling mud, reinjection of liquid petroleum, addition glycol or other viscous materials, materials that induce foaming and polymer additives that induce a high viscosity when dissolved in water. While some success has been achieved, the basic problem of high bypass of CO₂ through the field remains. Even minor improvements would be significant, if they could be assured to occur, given the large amount of capital investment in oil production and current oil prices. Embodiments of the present invention are designed to address these problems.

### SUMMARY

Described herein are novel technologies whereby large bypass pathways, where the largest fraction of unproductive CO₂ passes through the field, will be reduced or closed entirely by causing low viscosity liquids to flow into these regions and then greatly increasing the viscosity of these liquids by causing a chemical reaction to occur in situ. The result will be a plug that will force CO₂ through other regions of the oil field and thus cause more efficient production.

Some embodiments of the present invention provide methods for recovering crude oil from a subterranean hydrocarbon containing formation, comprising injecting the formation with a composition comprising an ionic liquid and displacing the crude oil with the composition injected into the formation to thereby recover hydrocarbons from a production well.

Some embodiments of the present invention provide compositions comprising an ionic liquid.

In some embodiments, when carbon dioxide (CO₂) is injected into an oil reservoir it becomes mutually soluble with the residual crude oil as light hydrocarbons from the oil dissolve in the CO₂ and CO₂ dissolves in the oil. This occurs most readily when the CO₂ density is high (when it is compressed) and when the oil contains a significant volume of “light” (i.e., lower carbon) hydrocarbons (typically a low-density crude oil). Below some minimum pressure, CO₂ and oil will no longer be miscible. As the temperature increases (and the CO₂ density decreases), or as the oil density increases (as the light hydrocarbon fraction decreases), the minimum pressure needed to attain oil/CO₂ miscibility increases. For this reason, oil field operators must consider the pressure of a depleted oil reservoir when evaluating its suitability for CO₂ enhanced oil recovery.

When the injected CO₂ and residual oil are miscible, the physical forces holding the two phases apart (interfacial tension) effectively disappears. This enables the CO₂ to displace the oil from the rock pores, pushing it towards a producing well. As CO₂ dissolves in the oil it swells the oil and reduces its viscosity. This affect also helps to improve the efficiency of the displacement process.

Often, CO₂ floods involve the injection of volumes of CO₂ alternated with volumes of water; water alternating gas, or WAG floods. This approach helps to mitigate the tendency for the lower viscosity CO₂ to finger its way ahead of the displaced oil.

In some embodiments, one or more ionic liquids (IL) is pumped into an injection well, then into the oil field and ultimately reacted with carbon dioxide. The reaction complex or product would have a viscosity such that it would create an almost “immovable” plug. Such plugs could be placed in strategic locations within the oil field to block low pressure-drop pathways, which would otherwise allow CO₂ to flow freely past still recoverable oil (i.e., finger past), hence maximizing the recovery of oil using carbon dioxide flooding. Note, that in principle, this method of flow control could be effective on small scales where fingering takes place, or over larger meter length scales of depleted regions of the field. This would result in improved oil recovery via optimized micro and macroscopic oil displacement, improved sweep efficiency, ability to control CO₂ from high permeability to low permeability “thief” zones, and improved CO₂ utilization.

Liquid flow in oil reservoirs occurs at very low Reynolds number (i.e., <<1) in a porous medium. Gas flow, particularly in fractured regions could be at much higher Reynolds numbers. The process of plugging gaps with the ionic liquid-carbon dioxide reaction complex likely occurs at a low Reynolds number.

The specific utility of using ionic liquids for this purpose is several-fold. The ILs will flow freely, if pumped with a liquid or nitrogen. The IL can then be placed at the best field location before reacting with CO₂, hence creating a viscous plug. The amount of IL will determine the size of the plug needed. A second advantage of ILs is that with options for anions and cations, they can be “chemically-tuned” for hydrophobicity and affinity for the particular “rock” that is present in the well. In addition, ILs can be tuned for the best performance at different temperatures that exist at various locations and also potentially adjusted as to their long-term degree of biological degradation. A third advantage is the IL-CO₂ reaction complex could also be implemented as a long-term carbon sequestration method should the economics of carbon sequestration favor it. Generally speaking, ionic liquids that could be used in the CO₂-EOR process are required to go from relatively low viscosity to very high viscosity upon contacting carbon dioxide.

In some embodiments, an alkanolamine is reacted with a simple organic acid to form a protic ionic liquid that would be able to subsequently react with CO₂. This ionic liquid should have accessible sites for forming hydrogen bonding and other intermolecular interactions. These are generally inexpensive starting materials and the resulting ionic liquids will be much cheaper than aprotic ionic liquids. The amine group on the cation should react with CO₂. There are many potential starting amino-alcohols. It is possible to place multiple nitrogens along the chain backbone, thereby creating multi-valent cations which may get extremely viscous upon reaction with CO₂.

In some embodiments, the methods comprise “protecting” the unreacted or “inactive” ionic liquid from prematurely reacting with CO₂. One way to do this would be to surround the reactive ionic liquid with slugs of “normal” ionic liquids or other liquids, which do not react with CO₂, or have low physical affinity for it. One could pump a sequence of normal liquid/ionic liquid—reactive ionic liquid—normal liquid/ionic liquid down a well, keeping all the liquids fluid until they reach the desired location. Then, either via a triggering mechanism or diffusion processes, CO₂ would be put into contact with the reactive ionic liquid, which would immediately get highly viscous at the right time and location.

### BRIEF DESCRIPTION OF THE DRAWING

FIG. 1 depicts the implementation of certain embodiments of the present invention in the field.

### DETAILED DESCRIPTION

As used herein, the terms “enhanced oil recovery” or “EOR” refer to processes for enhancing the recovery of hydrocarbons from subterranean reservoirs.

As used herein, the term “effective amount” refers to an amount required to complete the desired task or achieve the desired result. For example, “an effective amount of a traceable marker” refers to the amount of traceable marker required to detect ineffective plugging and as a consequence, undesirable oil fingering to map the geophysical structure of a subterranean hydrocarbon containing formation, e.g. an oil well.

As used herein, the term “minimum miscibility pressure” refers to the pressure at which carbon dioxide and a hydrocarbon, e.g. crude oil, become miscible.

As used herein, the term “plug” refers to a compound, composition, or chemical complex having a viscosity capable of diverting a gas or liquid into a region of a subterranean hydrocarbon containing formation to drive oil through the reservoir to producing wells.

As used herein, the terms “well”, “bed”, “reservoir” and “subterranean hydrocarbon containing formation” may be used interchangeably.

As used herein, the term “low viscosity” in the context of “low viscosity liquid(s)” refers a viscosity lower than the viscosity of crude oil.

Described herein are techniques, compounds and compositions for improving displacement efficiency or sweep efficiency useful for the exploitation of an oil field. In some embodiments, the methods of the present invention comprise introducing displacing fluids or gas into injection wells to drive oil through the reservoir to producing wells.

Some embodiments of the present invention provide methods for recovering crude oil from a subterranean hydrocarbon containing formation, comprising injecting the formation with a composition comprising an ionic liquid and displacing the crude oil with the composition injected into the formation to thereby recover hydrocarbons from a production well.

Some embodiments of the present invention provide compositions comprising an ionic liquid. In some embodiments, the ionic liquid is a protic ionic liquid. In some embodiments, the ionic liquid is an aprotic ionic liquid. In some embodiments, the ionic liquid comprises a compound containing an amine group. In some embodiments, the ionic liquid further comprises a hydrocarbon chain. In some embodiments, the ionic liquid further comprises an alcohol group that will cooperatively interact with CO₂ and any other highly electronegative atom effectively increasing the local viscosity. In some embodiments, the viscosity of the ionic liquid increase after contacting carbon dioxide. In some embodiments, the increase in viscosity is the result of an increase in hydrogen bonding.

In some embodiments, the composition comprises a compound containing an amine group, a hydrocarbon chain, and at least one hydroxyl group.

In some embodiments, the composition comprises an “inactive ionic liquid”. In some embodiments, the inactive ionic liquid will react with an activating agent to produce an “active ionic liquid”. In some embodiments, the activating agent is an organic acid (e.g., formic acid or acetic acid).

In some embodiments, the viscosity of the composition comprising the ionic liquid has a viscosity greater than about 100 cP at reservoir conditions. In some embodiments, the composition comprising the ionic liquid reacts with carbon dioxide to provide a composition having a viscosity in excess of 100 cP at reservoir conditions.

In some embodiments, the composition comprises a compound selected from:

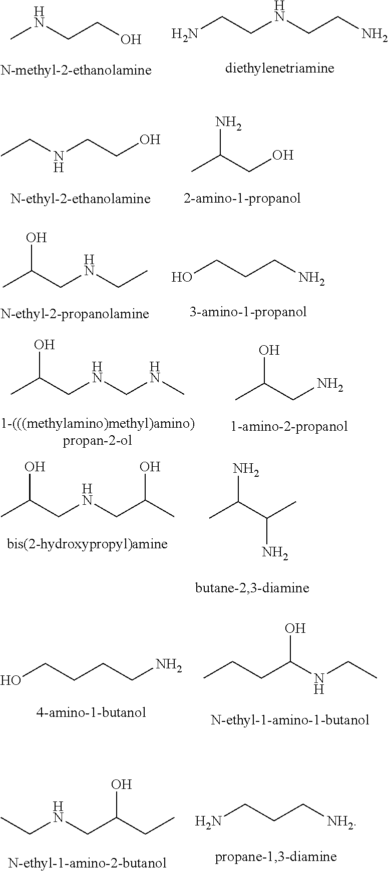

In some embodiments, the ionic liquid is protected to control the timing of its reaction with carbon dioxide. In some embodiments, the ionic liquid is encapsulated to control the timing of its reaction with carbon dioxide.

In some embodiments, the ionic liquid is protected to control the location of its reaction with carbon dioxide. In some embodiments, the ionic liquid is encapsulated to control the location of its reaction with carbon dioxide.

If they are then contacted with CO₂, they will likely react and get more viscous. If they are reacted with an organic acid (like formic acid or acetic acid) they will form a protic ionic liquid, which will likely also react with CO₂ and may get even more viscous.

In some embodiments, the composition comprises an ionic liquid which is a primary or secondary amine. Numerous variants of the compounds described herein may also be suitable for use in the methods of the present invention.

### Flow Geometry

Contrary to the standard “cartoons” where the CO₂ is shown pushing a wave of oil, it is almost certain, that most of the CO₂ merely bypasses any contact with oil and just flows through the most porous preferred pathways. Oil production is effected by a gradual “erosion” of the trapped oil in the vicinities of these fast pathways. As mentioned above this does work well enough for many situations to be profitable, but it is certainly not close to being efficient. If the best paths are “plugged”, this scenario will be altered both quantitatively and qualitatively. The “erosion” would be enhanced because the main flow would be reduced. In addition, the main flow path being plugged would force CO₂ into the low porosity regions where it may actually act to “push” aggregate amounts of oil through the field.

In some embodiments, single or multiple reactions occur in situ by pumping the composition comprising the ionic liquid down the same flow path that is currently taken up by the (largely bypassing) CO₂. In some embodiments wherein the water content of the reservoir is low, a composition comprising an inactive ionic liquid (e.g. a molecule or an ion containing an amino group) is injected into the subterranean hydrocarbon containing formation, followed by the injection of an activating agent (e.g. an organic acid) followed by injection of carbon dioxide.

In some embodiments, wherein the water content of the reservoir is high, the ionic liquid is “activated” at the surface. In some embodiments, the active ionic liquid is then injected into the reservoir. In some embodiments, the injection of an active ionic liquid will displace any water that is found along the preferred flow path. In some embodiments, carbon dioxide is then injected or pumped in the same path as the active ionic liquid. In some embodiments, the carbon dioxide will finger through the ionic liquid and mix on a scale small enough to allow for reaction.

In some embodiments, the reaction of the ionic liquid and carbon dioxide results in the formation of a plug. In some embodiments, the plug will force the CO₂ to flow through the less porous regions that contain more oil that could be recovered.

In some embodiments, the ionic liquid forms a complex with carbon dioxide. In some embodiments, the ionic liquid-CO₂ complex will have a viscosity of 100+ cP at reservoir conditions. While not intending to be bound by any theory, the expectation is that the rate of molecular diffusion of CO₂ through this reacted material will be negligible; and wherever the reaction occurs, it will be self-limiting by the lack of further CO₂ available to react. Hence only by flow through porous media, which could be by fingering of the CO₂ front through the rock, or the flow of liquid and CO₂ together through the porous bed, which induces dispersion, will the reaction proceed to produce highly viscous material.

In some embodiments, the technique will be applied to well-characterized fields in which CO₂ flooding has been occurring for some time. In some embodiments, this will enable the operators to know approximately where, in elevation, the low porosity regions are. Further, by conducting transient (i.e. cycling) pressurization of the well, some information about where in linear space, the most open pathways are located. (If the pressure response to increased flow is immediate, the region close to the well is not very porous. If a flow rate increase takes a long time for the pressure to respond, then the region near the well is more open.)

In some embodiments, this characterization will identify the appropriate amount of ionic liquid (presumably this will be 10's of bbls of ionic liquid) and/or activating agent that should be injected and it will follow the high porosity, most favorable flow path. This will ensure it is getting to the best place to plug.

If the region near the well is “tight” then care will need to be taken to make sure that the ionic liquid does not react close to the well opening. In this case, injection should be accomplished using nitrogen, or any other non-reactive, dry gas, or the ionic liquid plug should be followed by an inert, viscous liquid (e.g., glycerine). If the region near the well is open, then this is less of a concern. As part of the calculation for getting the liquid in the ideal spatial location, pumping will be switched to pressurization using CO₂ so that ultimately it will finger through the ionic liquid or amine-acid mixture to participate in the reaction.

In some embodiments, the particular ionic liquid, the particular activating agent and the amount of ionic liquid, activating agent and carbon dioxide will be tailored to a given well.

In those embodiments wherein the ionic liquid is synthesized on the surface, it is likely that an inert gas or liquid will not be needed behind the ionic liquid plug. In these embodiments, it may be possible to follow it immediately with CO₂ to get the reaction to occur in the bed.

In some embodiments, the compounds, compositions and methods of the present invention are designed to prevent situations in which the CO₂ never contacts the ionic liquid. In some embodiments, the compounds, compositions and methods of the present invention are designed to prevent situations in which the CO₂ does not contact the ionic liquid to an extent sufficient to react and form a ionic liquid plug. In some embodiments, the compounds, compositions and methods of the present invention are designed to prevent situations in which the CO₂ does not contact ionic liquid to an extent sufficient to increase the viscosity of the ionic liquid. In some embodiments, the compounds, compositions and methods of the present invention are designed to prevent situations in which the ionic liquid is pushed into the field too far and then any CO₂ that follows bypasses the ionic liquid plug.

In some embodiments, the methods comprise the use of alternating plugs of CO₂ and the ionic liquid which will allow them to mix when they get out of the well bore, into the field. In some embodiments, the length of the plugs will be adjusted depending on the effectiveness of dispersion that will occur inside the field.

In some embodiments, the methods, compounds and compositions described herein will be tailored to meet the temperature, pressure, fraction and pH of the water, porosity and degree of non-uniformity of the field.

Some embodiments of the present invention are directed to the recovery of crude oil from a subterranean hydrocarbon containing formation.

Some embodiments provide a method for targeted recovery of crude oil from a subterranean hydrocarbon containing formation, the method comprising: injecting an effective amount of a traceable marker into a subterranean hydrocarbon containing formation; identifying a high porosity zone in the formation; injecting into the high porosity zone a composition comprising an ionic liquid; and displacing crude oil from the formation. Some embodiments provide methods, processes and systems which comprise the step of recovering crude oil from a subterranean hydrocarbon containing formation. Some embodiments comprise the step of sequestering the recovered crude oil. In some embodiments, the methods comprise the step of further processing the crude oil.

In some embodiments, the traceable marker is a radioactive marker. In some embodiments, the traceable marker is an electromagnetic marker. In other embodiments, the traceable marker is a substance having a similar viscosity to carbon dioxide under subterranean conditions. In further embodiments, the traceable marker is a substance having a similar viscosity to carbon dioxide under atmospheric conditions. In some embodiments, the traceable marker is a substance having a similar viscosity to carbon dioxide under atmospheric and subterranean conditions. In some embodiments, the traceable marker comprises a gas.

In some embodiments, the gas is injected at an elevated temperature. In some embodiments, the traceable marker permits thermal mapping of the paths of least resistance in the hydrocarbon containing formation. In some embodiments, the traceable marker comprises a liquid.

In some embodiments, the high porosity zone has a pressure below the minimum miscibility pressure. In some embodiments, the high porosity zone is identified through receipt of a signal from the traceable marker. In some embodiments, the signal is audible, visual, or a general part of the electromagnetic spectrum.

Some embodiments further comprise the step of injecting an oil-miscible gas into the high porosity zone of the formation. In some embodiments, the oil-miscible gas comprises an inert gas. In some embodiments, the oil-miscible gas comprises carbon dioxide.

In some embodiments, the traceable marker comprises a modified carbon dioxide. In other embodiments, the modified carbon dioxide comprises a isotopically labeled carbon dioxide. In some embodiments, the traceable marker comprises a metallic compound.

In some embodiments, the composition comprising an ionic liquid increases in viscosity when contacted with carbon dioxide. In some embodiments, the composition comprising an ionic liquid forms a complex with the carbon dioxide. In some embodiments, the complex is in the form of a plug.

Other embodiments provide a method for recovering crude oil from a subterranean hydrocarbon containing formation, the method comprising: injecting an effective amount of a traceable marker into a subterranean hydrocarbon containing formation; identifying a region having a pressure below the minimum miscibility pressure; injecting a composition comprising an ionic liquid into the region having a pressure below the minimum miscibility pressure; and displacing crude oil from the formation.

Other embodiments provide a process for recovering crude oil from a subterranean hydrocarbon containing formation, the process comprising: obtaining a pressure reading from one or more locations in a subterranean hydrocarbon containing formation; selecting a location having a pressure below a minimum miscibility pressure; injecting a composition comprising an ionic liquid into said location having a pressure below the minimum miscibility pressure; and displacing crude oil from the formation. In some embodiments, the process further comprises the step of injecting carbon dioxide into the subterranean hydrocarbon containing formation. In some embodiments, the step of injecting carbon dioxide into the subterranean hydrocarbon containing formation takes place prior to the step of obtaining a pressure reading from one or more locations in a subterranean hydrocarbon containing formation.

Still further embodiments provide a composition for targeted recovery of crude oil from a subterranean hydrocarbon containing formation comprising: an ionic liquid; a controlled release coating. In some embodiments, the controlled release coating encapsulates the ionic liquid. In some embodiments, the controlled release coating comprises a heat-sensitive polymer. In other embodiments, the controlled release coating comprises a pressure-sensitive polymer. In some embodiments, the controlled release coating is adapted to dissolve under subterranean conditions. In some embodiments, the controlled release coating comprises an activating agent selected from: formic acid; acetic acid or any other suitable alkyl or functionalized carboxylic acid; and a combination thereof. In some embodiments, the encapsulated ionic liquid is an inactivated; and is activated only after dissolution of the controlled release coating. In some embodiments, the dissolution of the controlled release coating exposes the inactivated ionic liquid to any one of activating agents described herein.

Yet further embodiments provide an environmentally friendly method for recovering crude oil from a subterranean hydrocarbon containing formation, the method comprising: capturing an effective amount of carbon dioxide from an anthropogenic source; sequestering said effective amount of carbon dioxide; injecting said carbon dioxide into a subterranean hydrocarbon containing formation; and injecting a composition comprising an ionic liquid into a subterranean hydrocarbon containing formation. In some embodiments, the environmentally friendly method further comprises the step of identifying a region having a pressure below the minimum miscibility pressure.

In some embodiments, the region having a pressure below the minimum miscibility pressure is identified using subterranean mapping techniques. In some embodiments, the region having a pressure below the minimum miscibility pressure is identified using seismic energy. In some embodiments, the region having a pressure below the minimum miscibility pressure is identified using an airborne antenna system (e.g. the system developed by Subterranean Mapping Systems, LLC).

Some embodiments provide a system for recovering crude oil from a subterranean hydrocarbon containing formation, comprising: an ionic liquid; means for detecting pressure in a subterranean hydrocarbon containing formation; and an oil-miscible gas.

In some embodiments, well logging or borehole logging methods are used to understand geophysical structure of subterranean hydrocarbon containing formations. In these methods, a log is created based either on visual inspection of samples brought to the surface (geological logs) or on physical measurements made by instruments lowered into the hole (geophysical logs). Some types of geophysical well logs can be done during any phase of a well's history: drilling, completing, producing, or abandoning. Well logging is performed in boreholes drilled for the oil and gas, groundwater, mineral and geothermal exploration, as well as part of environmental and geotechnical studies.

In some embodiments, wireline logging methods are used. Wireline logging methods obtain a continuous record of a formation's rock properties by lowering a ‘logging tool’—or a string of one or more instruments—on the end of a wireline into an oil well (or borehole) and recording petrophysical properties using a variety of sensors. Logging tools developed over the years measure the natural gamma ray, electrical, acoustic, stimulated radioactive responses, electromagnetic, nuclear magnetic resonance, pressure and other properties of the rocks and their contained fluids.

In some embodiments, the ionic liquid is “doped with Potassium (Gamma ray energy 1.46 MeV), Thorium (Gamma ray energy 2.61 MeV) or Uranium-Radium (Gamma ray energy 1.76 MeV) so such radiation could be detected by gamma detectors located at different points of the reservoir if a IL-CO₂ plug has been “broken”.

In some embodiments, nuclear magnetic resonance (NMR) logging is a potential tracking technique, e.g. ¹³C from CO₂ can be detected by NMR spectroscopy. In some embodiments, the methods comprise the step of isotopically labeling CO₂ with ¹³CO₂ to increase the chances of plug malfunctions via NMR logging. In some embodiments, the isotopically labeled CO₂ or doped ionic liquid will permit detection of an IL-CO₂ plug break or leak. In some embodiments the IL-CO₂ plug break or leak can be detected by monitoring the reservoir with the appropriate instruments down boreholes strategically placed around it.

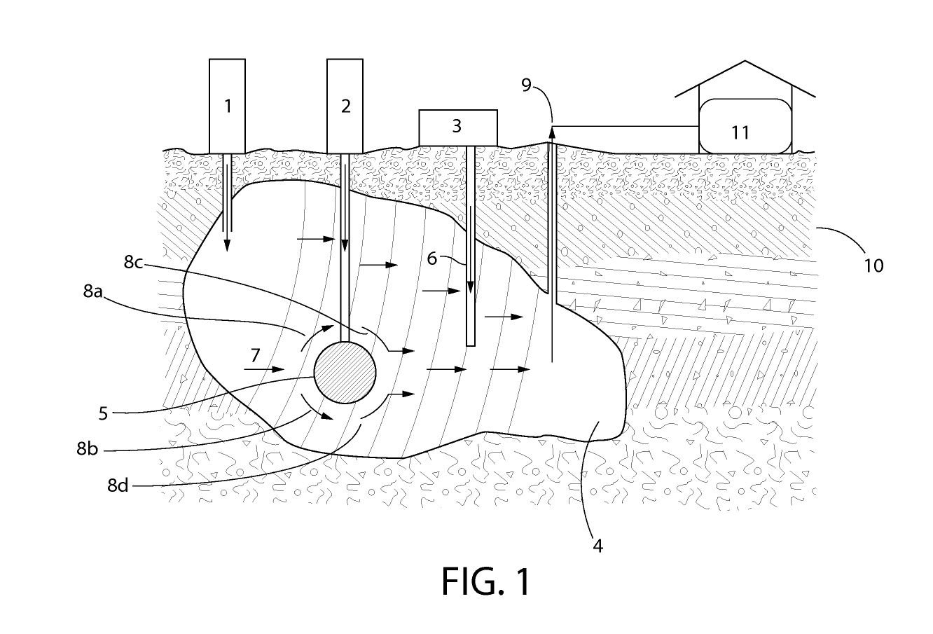

FIG. 1 depicts an exemplary system for targeted recovery of crude oil from a subterranean hydrocarbon containing formation 10. In some embodiments, the system includes a source of carbon dioxide and a source of a traceable marker 1, an ionic liquid composition 2; a means for obtaining a pressure reading from one or more locations in a subterranean hydrocarbon containing formation 3, and an ionic liquid/carbon dioxide complex 5. In some embodiments, the ionic liquid/carbon dioxide complex 5 is in the form of a plug which is placed in a strategic location within the oil field to block a low pressure-drop pathway 7, which would otherwise allow CO₂ to flow freely past still recoverable oil. As depicted in FIG. 1, the strategically placed ionic liquid/carbon dioxide complex 5, diverts the carbon dioxide from a pathway having a pressure below the minimum miscibility pressure 7 into the low porosity regions (8a, 8b, 8c, 8d) where it may actually act to “push” aggregate amounts of oil through the field 9. In some embodiments, this results in improved oil recovery via optimized micro and macroscopic oil displacement, improved sweep efficiency, ability to control CO₂ from high permeability to low permeability “thief” zones, and improved CO₂ utilization. In some embodiments, the means for obtaining a pressure reading from one or more locations in a subterranean hydrocarbon containing formation 3 emits a signal and receives a return signal 6, both of which are used to calculate the pressure in the reservoir 4 of a subterranean hydrocarbon containing formation 10. In some embodiments, the recovered crude oil is stored/sequestered in a container 11, for further processing.

The invention will be described in greater detail by way of specific examples. The following examples are offered for illustrative purposes and are not intended to limit the invention in any manner.

### EXAMPLES

### Example 1

### In Situ High-Viscosity Ionic Liquids

Amines and acids are reacted to form ionic liquids that have high viscosity due the formation of networks of strong hydrogen bonds. The following scheme describes the generic chemistry of this reaction:

R¹R²NH+R³COOH→[R¹R²NH₂]⁺[R³COO]

wherein R¹, R² and R³ are each independently H, —OH, C₁-C₂₀ alkyl, amino, amido or other organic functional group.

The viscosity of these ILs can be enhanced in several ways, by providing further sites through which to form hydrogen bonding linkages. Described below are four ways in which this can be accomplished:
1. R¹, R², and/or R³ can be chosen to contain further hydrogen bonding functional groups. One common group is an alcohol functionality, although others, for instance halogens, ethers, esters, etc., could be considered. The figure below shows representative examples in which an organic acid is combined with a secondary amine in which R² is alcohol functionalized, providing a secondary hydrogen bonding site.

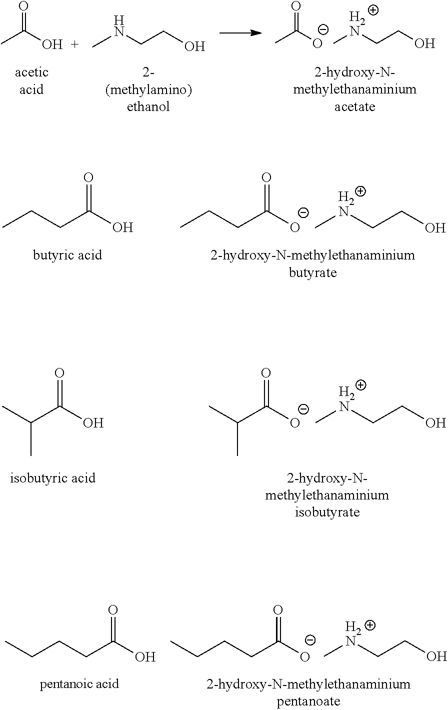

2. R¹, R², and/or R³ can be chosen to contain additional amine groups, i.e. to contain polyamines. The figure below shows an example in which a single equivalent of organic acid is combined with a diamine:

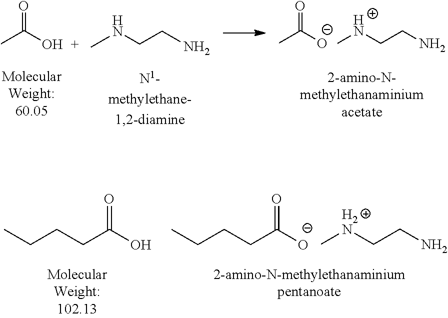

This chemistry can be continued by adding up to one equivalent of acid to each equivalent of amine to form a polyelectrolytic IL gel:

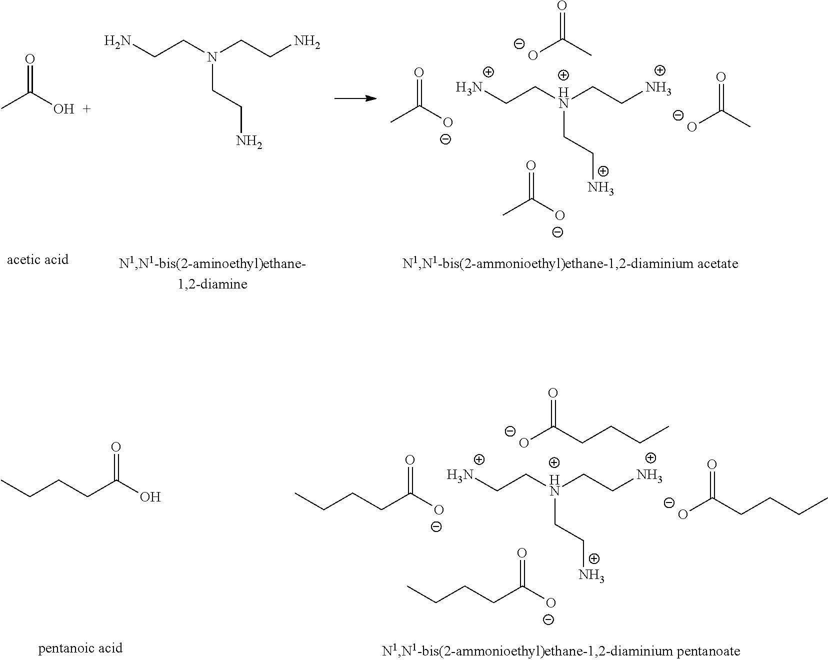

3. Concepts (1) and (2) can be combined, such that a polyamine is selected that also contains additional hydrogen bonding functional groups. The figure below illustrates an alcohol-functionalized diamine combining with an organic acid:

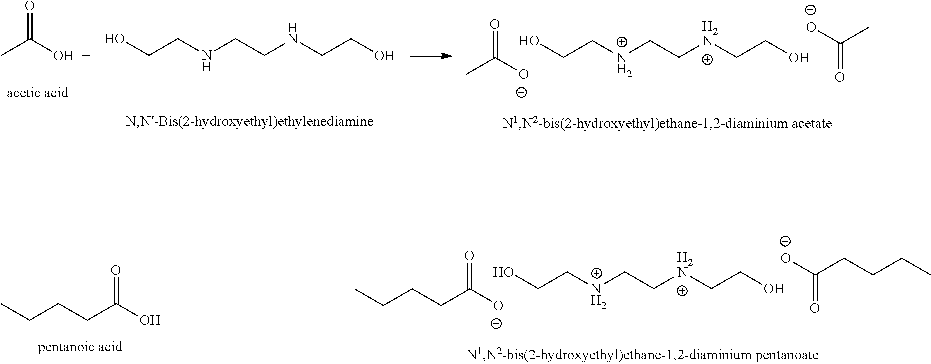

3. In a variation on these ideas, the amine and the acid could be incorporated into a single molecule. Such liquids are (likely) intrinsically viscous. The formation of a viscous IL would be triggered in this case by the addition of a strong base that deprotonates the acid and forms an IL with the countercation of the base:

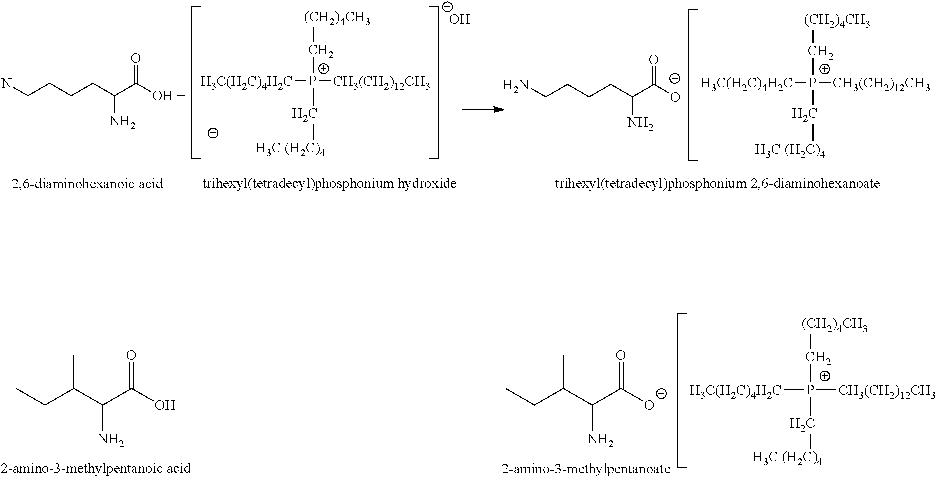

### Example 2

### CO₂-Enhancement of Viscosity

Each of the chemistries described above can be further triggered or enhanced by the presentation of CO₂ to the ionic liquid or composition comprising same. The overall CO₂ chemistry involves the reaction of CO₂ with two equivalents of an amine and an acid:

2R¹R²NH+2R³COOH+CO₂→[R¹R²NH₂]⁺[R¹R²NHCO₂]⁻+[R¹R²NH₂]⁺[R³COO]⁻

The advantage of this approach is that it provides a way to trigger changes in physical properties through the addition of CO₂ and, that by providing additional hydrogen bonding centers, can further enhance viscosity. This carbamate chemistry can be combined with any of the single or polyamine ideas described above, and could be enhanced or tuned through the addition of other hydrogen-bonding functional groups, also as described above.

### Example 3

### Tertiary Amine Chemistries

Aliphatic tertiary amines in general do not react directly with CO₂. Nonetheless, viscous ionic liquids can be produced through acid-base chemistries like that described above. The figure below shows examples of organic acids reacting with a ditertiary amine that is further functionalized with alcohol groups. This chemistry could be carried out with simpler monoamines, with or without additional functional groups.

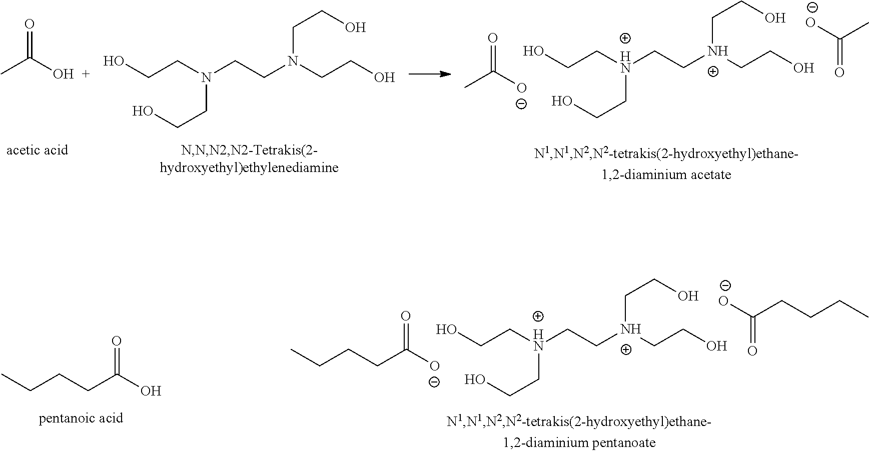

### Example 4

### Exemplary Amines

Following is a non-exhaustive list of compounds suitable for use in the compositions and methods described herein.

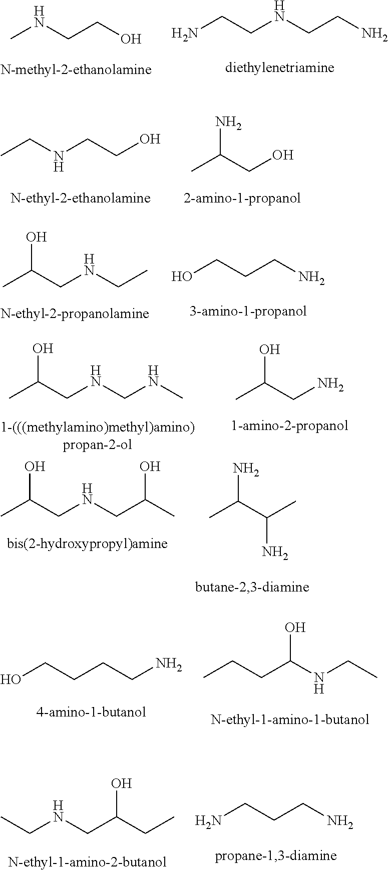

### Example 5

### Encapsulation of Ionic Liquids

These candidates could be used to protect the in situ high-viscosity ionic liquids before they reach their intended destination.

### Cation Encapsulation Candidates

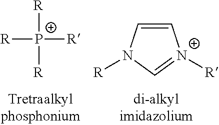 [0078] R=alkyl chain
R′=alkyl chain
Where R and R′ can have equal or different lengths

### Anion Encapsulation Candidates

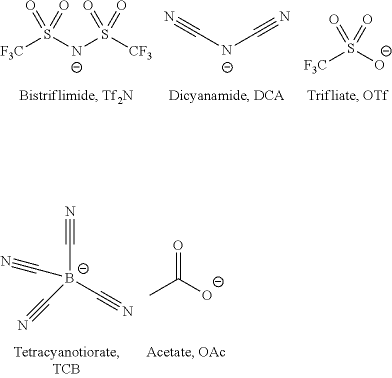

### Example 6

2-(Methylamino)ethanol is measured into a round bottom flask equipped with stir bar, and mixed with a similar volume of distilled water. An equimolar amount of the desired acid (acetic, butyric, iso-butiric or pentanoic) is measured into an addition funnel and mixed with a similar volume of distilled water. Addition of the acid solution to the base solution is performed dropwise, with vigorous stifling and at 0° C. The reaction mixture is allowed to stir for 30 minutes to 72 hrs. Volatiles are evaporated under reduced pressure, first in a rotary evaporator for at least 3 hrs and then in a vacuum line at temperatures between 60-80° C. over several days. The final products are characterized by ¹H and ¹³C NMR spectrometry.

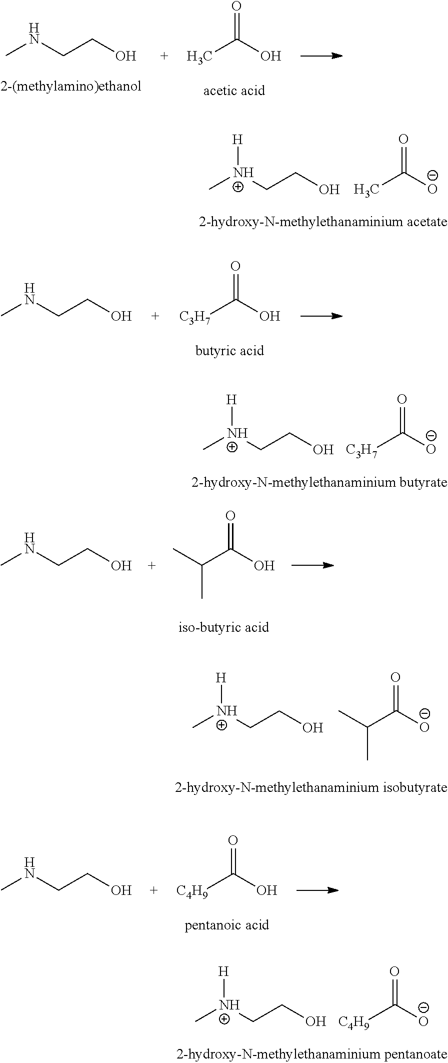

It is intended that any patents, patent applications or printed publications, including books, mentioned in this patent document be hereby incorporated by reference in their entirety.

As those skilled in the art will appreciate, numerous changes and modifications may be made to the embodiments described herein, without departing from the spirit of the invention. It is intended that all such variations fall within the scope of the invention.

1-64. (canceled)

65. A method for targeted recovery of crude oil from a subterranean hydrocarbon containing formation, the method comprising:
injecting an effective amount of a traceable marker into a subterranean hydrocarbon containing formation;
identifying a region having a pressure below the minimum miscibility pressure;
injecting a composition comprising an ionic liquid into the region having a pressure below the minimum miscibility pressure; and
recovering crude oil from the formation.

66. The method of claim 65, wherein the traceable marker is a substance having a similar viscosity to carbon dioxide under subterranean conditions.

67. The method of claim 66, wherein the traceable marker comprises a gas.

68. The method of claim 66, wherein the traceable marker provides a thermal mapping of the path of least resistance for CO₂.

69. The method of claim 65, wherein the region having a pressure below the minimum miscibility pressure is identified through receipt of a signal from the traceable marker.

70. The method of claim 65, wherein the traceable marker comprises a modified carbon dioxide.

71. The method of claim 65, wherein the composition comprising an ionic liquid increases in viscosity when contacted with carbon dioxide.

72. The method of claim 71, wherein the composition comprising an ionic liquid forms a complex with the carbon dioxide.

73. The method of claim 72, wherein the complex is in the form of a plug.

74. An environmentally friendly process for recovering crude oil from a subterranean hydrocarbon containing formation, the process comprising:
obtaining a pressure reading from one or more locations in a subterranean hydrocarbon containing formation;
selecting a location having a pressure below a minimum miscibility pressure;
injecting a composition comprising an ionic liquid into said location having a pressure below the minimum miscibility pressure; and
recovering crude oil from the formation.

75. The process of claim 74, further comprising the step of injecting carbon dioxide into the subterranean hydrocarbon containing formation.

76. The process of claim 75, wherein the step of injecting carbon dioxide into the subterranean hydrocarbon containing formation takes place prior to the step of obtaining a pressure reading from one or more locations in a subterranean hydrocarbon containing formation.

77. The process of claim 75, wherein the carbon dioxide is captured from an anthropogenic source.

78. A composition for targeted recovery of crude oil from a subterranean hydrocarbon containing formation comprising:
an ionic liquid;
a controlled release coating.

79. The composition of claim 78, wherein the controlled release coating encapsulates the ionic liquid.

80. The composition of claim 79, wherein the controlled release coating comprises a heat-sensitive polymer.

81. The composition of claim 79, wherein the controlled release coating is adapted to dissolve under subterranean conditions.

82. The composition of claim 78, wherein the ionic liquid comprises a compound selected from:

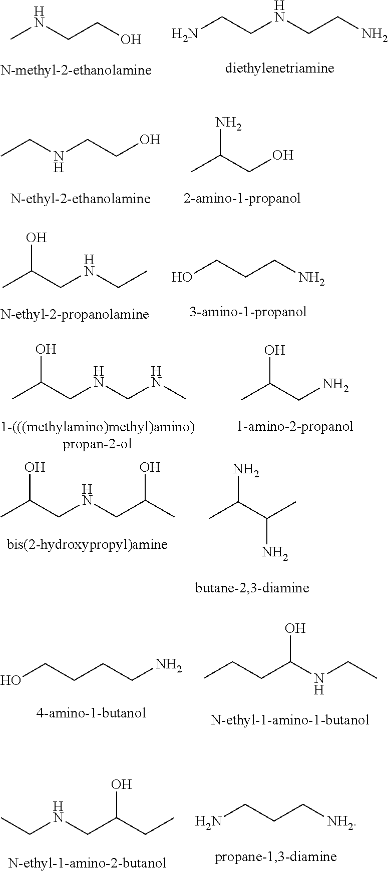

83. The composition of claim 81, wherein the ionic liquid is inactivated.

84. The composition of claim 83, wherein the controlled release coating comprises an activating agent selected from: formic acid; acetic acid or any other suitable alkyl or functionalized carboxylic acid; and a combination thereof.
